(19) United States
(12) Patent Application Publication
(10) Pub. No.: US 2023/0357619 A1
(43) Pub. Date: Nov. 9, 2023

(54) METHYLPOLYSILOXANE MIXTURES AS A HEAT-CARRIER FLUID

(71) Applicant: WACKER CHEMIE AG, Munich (DE)

(72) Inventors: Maximilian Moxter, Munich (DE); Julia Haffendorn, Munich (DE); Lukas Kokott, Garching (DE); Richard Weidner, Burghausen (DE)

(73) Assignee: Wacker Chemie AG, Munich (DE)

(21) Appl. No.: 17/777,527

(22) PCT Filed: Nov. 18, 2019
(86) PCT No.: PCT/EP2019/081642

§ 371 Date: May 17, 2022

(51) Int. Cl. C09K 5/10; F24S 80/20

(52) U.S. Cl. CPC C09K 5/10; F24S 80/20

(57) ABSTRACT

A methylpolysiloxane mixture along with uses and methods for operating a solar thermal power station (or CSP plant) utilizing the same. The use for the methylpolysiloxane mixture includes providing a mixture (a) wherein the methylpolysiloxane mixture includes a linear methylpolysiloxanes MDₓM, wherein x is an integer with 0≤x≤100, and wherein the mixtures have a molar M:D ratio of 1:15.5 to 1:30; or (b) wherein the methylpolysiloxane mixture includes a linear methylpolysiloxanes MDₓM, wherein x is an integer with 0≤x≤80 and cyclic dimethylpolysiloxanes D_{y} where y is an integer≥3, wherein the sum of the fractions of all cyclic dimethylpolysiloxanes D_{y} is 10-95 wt %, and wherein the mixtures have a molar M:D ratio of 1:10.5 to 1:30. The methylpolysiloxane mixture is used as a heat transfer fluid in a CSP plant with operating temperatures in a range of 300 to 500° C.

The subject matter of the present invention is the use of methylpolysiloxane mixtures as heat transfer fluid and also specific methylpolysiloxane mixtures and a method for operating a CSP plant with these mixtures.

Low-viscosity mixtures of linear and cyclic methylpolysiloxanes are currently used as the heat transfer oil (e.g. Helisol® 5A) in CSP plants (CSP=Concentrated Solar Power, solar thermal power station with ray concentration). As a consequence of the low viscosity, equilibration causes the oil to comprise sizeable fractions of low-boiling constituents, meaning first that the critical point of the mixture is below the operating temperature and secondly that the operating pressure of the plant is 20 bar or more.

In order to ensure a constantly high operating pressure from the outset, the prior art has made use, for example, of the addition of low-boiling cyclic compounds to the heat transfer oil. DE102012211258A1 (WO2014/001081) for this purpose discloses mixtures of at least two methylpolysiloxanes, selected from linear compounds of the general formula (I)

Me₃SiO—(Me₂SiO)ₓ—SiMe₃ (I),

and cyclic compounds of the general formula (II)

[Me₂SiO]_{y} (II),

where the mixture comprises at least one linear methylpolysiloxane of the general formula (I) and at least one cyclic methylpolysiloxane of the general formula (II), with x having values of greater than or equal to zero and with the arithmetic mean of x weighted by the amount-of-substance fractions over all the linear methylpolysiloxanes being between 3 and 20, and with y having values of greater than or equal to 3 and with the arithmetic mean of y weighted by the amount-of-substance fractions over all cyclic methylpolysiloxanes being between 3 and 6, where the numerical ratio of the Me₃Si chain end groups (M) in the compounds of the general formula (I) to the sum of Me₂SiO units (D) in the compounds of the general formula (I) and (II) is at least 1:2 and at most 1:10, the sum of the fractions of all cyclic methylpolysiloxanes of the general formula (II) is at least 10 mass % and at most 40 mass %, and the mixture at 25° C. is liquid and has a viscosity of less than 100 mPa*s; moreover, the individual methylpolysiloxanes of the formulae (I) and (II) are required to be present in specific proportions. Siloxane mixtures of these kinds are suitable as heat transfer fluid for CSP plants with an operating temperature in the range from 200 to 550° C.

WO2019/072403 discloses a methylpolysiloxane mixture comprising methylpolysiloxanes having Me₃Si chain end groups (M) and Me₂SiO units (D), where the molar M:D ratio in the methylpolysiloxane mixture is 1:5.5 to 1:15 and the sum of the fractions of all cyclic methylpolysiloxanes is 25 to 55 mass %. This mixture is suitable as a heat transfer fluid in CSP plants. The mixture reaches the critical point only at temperatures above 400° C. Mixtures having a higher M:D ratio are deprecated, since as the initial chain length of the molecules goes up, there is a sharper increase in viscosity because of the formation of T units and the associated increase in molar mass of the molecules at the operating temperature. This would necessitate significantly higher pumping power and might result in mixtures which can no longer be pumped.

WO2010/103103 discloses the use of low molecular mass polyorganosiloxanes of the formula MₐD_{b}T_{c}Qₑ with a=2-6, b=0-10, c=0-3, d=0-2, c+d=1-2, a/(c+d)=>2, with M=R₃SiO_{1/2} and

D=R₂SiO_{2/2} and T=RSiO_{3/2} and Q=SiO_{4/2}, in which R is selected from the group consisting of: aliphatic and/or aromatic moieties having up to 30 carbon atoms, which may comprise one or more oxygen atoms, one or more halogen atoms and one or more cyano groups, with the proviso that at least one of the moieties R in M (terminal group) is bonded to silicon via a carbon atom and at least one of the moieties R in M has at least two carbon atoms, as power and/or heat transfer fluid. The technical problem addressed is a desired reduction in seal swelling.

EP1473346 discloses a mixture of at least two dimethylpolysiloxanes which are selected from dimethylpolysiloxanes of the formula (1) or (2)

Me₃SiO—(Me₂SiO)ₘ—SiMe₃ (1)

[Me₂SiO]ₙ (2),

where m is an integer with 0≤m≤10 and n is an integer with 3≤n≤10, where one of the dimethylpolysiloxanes is dodecamethylpentasiloxane, which is present in a fraction of 15-95 wt % based on the total weight of the mixture, and the mixture has a moisture content of at most 50 ppm, based on the total weight of the mixture. The mixture is used as a coolant and has a viscosity of ≤2 mm²/s at 25° C. and of 300 mm²/s at −100° C.

The critical point describes the thermodynamic state of a system in which the physical properties/variables of all coexisting phases are the same. In the case of a mixture of substances, the critical point is defined by reference to the molecular composition of the mixture and is characterized by a significant drop in the density. Methylpolysiloxanes of relatively low molar mass, more particularly linear methylpolysiloxanes MM (Si2), MDM (Si3), MD₂M (Si4), etc., and cyclic methylpolysiloxanes D3, D4, D5, etc., enter the supercritical state at a relatively low temperature (see Table 1). Hence for the linear methylpolysiloxanes up to Si8 and for the cyclic methylpolysiloxanes up to D8, the critical temperature is below the target operating temperature of a heat transfer fluid of 425° C.

TABLE 1
Selected pure-compound data for linear and cyclic
siloxanes (database: ASPEN DB-PURE28)

| Six | 2 | 4 | 6 | 8 | 12 |
|---|---|---|---|---|---|
| Critical temperature [° C.] | 245.8 | 326.3 | 380.05 | 415.8 | 478.2 |
| Dy | 3 | 4 | 5 | 6 | 8 |
| Critical temperature [° C.] | 281.1 | 313.4 | 346.0 | 372.7 | 416.1 |

Under thermal load, methylpolysiloxanes undergo a rearrangement: they equilibrate. Independently of the initial composition, the result is a methylpolysiloxane mixture of linear methylpolysiloxanes (Si2, Si3, Si4, etc.) and cyclic dimethylpolysiloxanes (D3, D4, D5, etc.) which is in thermal thermodynamic equilibrium. The position of this equilibrium is governed by the maximum operating temperature to which the methylpolysiloxane mixture is subject and by the molar M:D ratio of the methylpolysiloxane mixture. At high temperatures, such as 425° C., for example, the equilibrium is established within 1-2 months (long-term exposure). At lower temperatures, a different equilibrium is established; at 400° C., however, the establishment of equilibrium already takes 2-4 months. In practical operation for a heat transfer fluid, therefore, especially in the operation of a CSP power station, the equilibrium established is, after a certain time, always that of the highest maximum operating temperature, since the rate constant for establishment of the equilibrium at a relatively high temperature is greater than the rate constant for establishment of the equilibrium at a relatively low temperature (corresponding to reverse reaction/re-equilibration). The residence time of the heat transfer fluid in the practical operation of a CSP power station at maximum operating temperature is relatively short (receiver end to evaporator). In the evaporator the heat transfer fluid is cooled very rapidly to 300° C., and at these temperatures equilibration is only very slow.

The object is therefore to provide methylpolysiloxane mixtures which
(a) in the initial state, in spite of constituents of relatively high molecular mass, have a low viscosity—even at temperatures below 0° C.,
(b) have the critical point above the operating temperature of CSP plants, ideally above 425° C.,
(c) in the equilibrated state have a low vapor pressure (<20 bar),
(d) in the equilibrated state still have a viscosity<20 mPa*s, and
(e) in spite of constituents of relatively high molecular mass, because of insignificant degradation, exhibit long-term stability in their profiles of properties (e.g., viscosity) and can therefore be employed economically.

Surprisingly it has been found that in methylpolysiloxanes of relatively high molecular mass—such as the methylpolysiloxane mixtures of the invention—under CSP-relevant conditions of 425° C. significantly more cyclic compounds are formed than in the mixtures that from the outset are of low molecular mass. As a consequence of this, the viscosity drop of the higher-molecular-mass mixtures is significantly more pronounced than has been known to date. At the same time the vapor pressure of the equilibrated mixtures is lower than for a low-molecular-mass mixture, despite the mixtures of higher molecular mass forming significantly more low-boiling cyclic compounds. The measurements also show that the methylpolysiloxane mixtures of the invention are likewise subcritical in the region of the operating temperature.

These aspects were hitherto unknown and thus constitute an advantage for the utilization of relatively high-molecular-mass methylpolysiloxanes as heat transfer fluid in CSP plants.

The Mueller-Rochow process is designed for the preparation of the difunctional precursor dimethyldichlorosilane; in comparison, trimethylchlorosilane as a precursor for M units, constitutes a minor component. Siloxane mixtures with a relatively high M:D ratio are more resource-efficient, since they contain more dimethylsilyloxy groups (D units) and fewer trimethylsilyloxy groups (M units) than the same quantity of a comparable polydimethylsiloxane mixture of low viscosity.

The technical object is achieved through the use of methylpolysiloxane mixtures as described in claims 1-5 and also by methylpolysiloxane mixtures as described in claims 6-11.

One subject of the invention is the use of methylpolysiloxane mixtures which
(a) comprise linear methylpolysiloxanes MDₓM in which x is an integer with 0≤x≤100, and where the mixtures have a molar M:D ratio of 1:15.5 to 1:30; or
(b) comprise linear methylpolysiloxanes MDₓM in which x is an integer with 0≤x≤80 and cyclic dimethylpolysiloxanes D_{y} in which y is an integer≥3, wherein the sum of the fractions of all cyclic dimethylpolysiloxanes D_{y} is 10-95 wt %, and where the mixtures have a molar M:D ratio of 1:10.5 to 1:30,
   as heat transfer fluid in solar thermal power stations (CSP) with operating temperatures in a range of 300 to 500° C., preferably in a range from 380° C. to 450° C., more particularly at temperatures in the range from 400° C. to 430° C.

Preference is given to using methylpolysiloxane mixtures for which:
(a) the mixtures have a molar M:D ratio of 1:15.5-1:25; or
(b) the mixtures comprise linear methylpolysiloxanes MDₓM in which x is an integer with 0≤x≤29, and cyclic dimethylpolysiloxanes D_{y} in which y is an integer with 3≤y≤10, where the sum of the fractions of all cyclic dimethylpolysiloxanes D_{y} is in a range from 60-80 wt %, and where the mixtures have a molar M:D ratio of 1:11 to 1:20.

Particular preference is given to using methylpolysiloxane mixtures for which:
a) the sum of the fractions of all cyclic dimethylpolysiloxanes D_{y} is in a range from 0-1 wt %, the number average M̅ₙ n of the mixture is in a range from 400 to 3000 g/mol, and the weight average M̅_{w} of the mixture is in a range from 1000 to 5000 g/mol; or
b) the mixtures comprise linear methylpolysiloxanes MDₓM in which x is an integer with 0≤x≤29, and cyclic dimethylpolysiloxanes D_{y} in which y is an integer with 3≤y≤where the sum of the fractions of all cyclic dimethylpolysiloxanes D_{y} is in a range from 60-80 wt %, and where the mixtures have a molar M:D ratio of 1:11 to 1:20 and the number average M̅ₙ of the mixture is in a range from 100 to 2000 g/mol and the weight average M̅_{w} of the mixture is in a range from 100 to 6000 g/mol.

As a result of the preparation process, the stated methylpolysiloxane mixtures may include small amounts of T and/or Q groups, with the mixtures containing at most 150 ppm of T groups and at most 100 ppm of Q groups. Preferably the methylpolysiloxane mixtures contain at most 100 ppm of T groups and no Q groups.

A further subject of the invention are methylpolysiloxane mixtures which comprise linear methylpolysiloxanes MDₓM in which x is an integer with 0≤x≤80 and cyclic dimethylpolysiloxanes D_{y} in which y is an integer≥3, where the sum of the fractions of all cyclic dimethylpolysiloxanes D_{y} is 10-95 wt %, and where the mixtures have a molar M:D ratio of 1:10.5 to 1:30.

MDₓM typically denotes linear, methyl-end-stopped dimethylpolysiloxanes of the formula (I)

(CH₃)₃Si—O—[CH₃SiO]ₓ—Si(CH₃)₃ (I),

where x is an integer≥0. For simplification these linear methylpolysiloxanes are also called Six, where Si2 stands for the disiloxane MM, Si3 for MDM, Si4 for MD2M, etc.

D_{y} typically denotes cyclic dimethylpolysiloxanes of the formula (II)

[CH₃SiO]_{y} (II),

where y is an integer≥3.

Preferred methylpolysiloxane mixtures are those which comprise linear methylpolysiloxanes MDₓM in which x is an integer with 0≤x≤29, and cyclic dimethylpolysiloxanes D_{y} in which y is an integer with 3≤y≤10, where the sum of the fractions of all cyclic dimethylpolysiloxanes D_{y} is in a range from 60-80 wt %, and where the mixtures have a molar M:D ratio of 1:11 to 1:20 and the number average M̅ₙ of the mixtures is in a range from 100 to 2000 g/mol and the weight average M̅_{w} of the mixtures is in a range from 100 to 6000 g/mol.

Particularly preferred methylpolysiloxane mixtures are those where the number average M̅ₙ of the mixtures is in a range from 200 to 1600 g/mol and the weight average M̅_{w} of the mixtures is in a range from 200 to 2200 g/mol. Very preferably the number average M̅ₙ of the mixtures is in a range from 250 to 1400 g/mol and the weight average M̅_{w} of the mixtures is in a range from 250 to 2000 g/mol.

The methylpolysiloxane mixtures of the invention have a viscosity at 25° C. of ≤100 mPa*s and a viscosity at −40° C. of ≤300 mPa*s. Preferably they have a viscosity at 25° C. of ≤50 mPa*s and a viscosity at −40° C. of ≤200 mPa*s.

The methylpolysiloxane mixtures of the invention in the equilibrium state have a viscosity at 25° C. of ≤20 mPa*s.

The methylpolysiloxane mixtures of the invention have their critical point at a temperature of ≥430° C. Preferably they have their critical point at a temperature of ≥440° C.

The methylpolysiloxane mixtures of the invention in the equilibrium state have a vapor pressure of ≤20 bar at 425° C. at a filling level of 45%, a vapor pressure being preferably ≤18 bar and more preferably ≤17 bar.

As a result of the preparation process, the methylpolysiloxane mixtures of the invention may include small amounts of T and/or Q groups, with the mixtures containing at most 150 ppm of T groups and at most 100 ppm of Q groups. Preferably the methylpolysiloxane mixtures contain at most 100 ppm of T groups and no Q groups.

Methylpolysiloxane mixtures of the invention may be prepared by providing methylpolysiloxanes Six or Dy or any desired mixtures of such methylpolysiloxanes, in any order, mixing them and metering them into one another, these operations optionally also being multiply repeated, optionally also in alternation or simultaneously, so that the conditions stated above for x, y, molar M:D ratio and also number average and weight average are fulfilled. Through suitable methods, distillation for example, individual methylpolysiloxanes or methylpolysiloxane mixtures may also be removed again. The composition of the methylpolysiloxane mixtures of the invention here may be controlled by the amounts of methylpolysiloxanes Six and Dy that are used or removed.

The process may be carried out at room temperature and ambient pressure, or alternatively at elevated or reduced temperature and also elevated or reduced pressure.

Methylpolysiloxane mixtures of the invention may additionally be prepared by subjecting suitable chlorosilanes, alkoxysilanes, or mixtures of chlorosilanes or alkoxysilanes, to hydrolysis or co-hydrolysis and subsequently freeing them from byproducts such as hydrogen chloride or alcohols and also, where appropriate, from excess water. Optionally it is possible for one or more further methylpolysiloxanes to be added to the resulting methylpolysiloxane mixture or for removal to take place by suitable methods, distillation for example. The process may be carried out at room temperature and ambient pressure, or alternatively at elevated or reduced temperature and also elevated or reduced pressure. The composition of the methylpolysiloxane mixtures of the invention here is controlled by the ratio of the quantities of silanes and/or methylpolysiloxanes that are used and, where appropriate, removed again.

The processes described above may also be combined. They may be carried out optionally in the presence of one or more solvents. Preferably no solvent is used. The silanes, silane mixtures, methylpolysiloxanes and methylpolysiloxane mixtures that are used are either commercially available products of the silicone industry, or they may be prepared by synthesis methods known from the literature.

The methylpolysiloxane mixtures of the invention may comprise dissolved or suspended or emulsified additives in order to increase their stability or to influence their physical properties. Dissolved metal compounds, iron carboxylates for example, may act as radical scavengers and oxidation inhibitors to increase the durability of the methylpolysiloxane mixtures, particularly when they are used as a heat transfer fluid. Suspended additives, such as carbon or iron oxide, for example, may improve physical properties of a heat transfer fluid, such as the heat capacity or the thermal conductivity, for example.

A further subject of the invention is a method for operating a CSP plant which comprises using the methylpolysiloxane mixtures of the invention as heat transfer fluid and gradually increasing the temperature during startup of the plant. As a result the vapor pressure of the heat transfer fluid in the equilibration phase is kept below the operating pressure.

In a preferred method the gradual startup comprises the following steps:
a) Establishing a start temperature which is 100 to 200° C. below the maximum operating temperature but is at least 100° C.;
b) Holding the start temperature until a constant operating pressure is maintained for at least 3 hours;
c) Increasing the operating temperature by a value in a range of 5-150° C., preferably in a range of 25-100° C., more preferably in a range of 25-50° C.,
d) Holding the temperature until a constant operating pressure is maintained for at least 3 hours;
e) Repeating steps c) and d) until the maximum operating temperature is reached.

### EXAMPLES

### Measurement Methods

### 1. Determining the Composition of the methylpolysiloxane Mixtures

### Gas Chromatography (GC)

The composition of the methylpolysiloxane mixtures was determined by GC. Instrument: Agilent GC-3900 gas chromatograph, column MXT5 (60 m×0.28 mm, 0.25 μm), carrier gas hydrogen, flow rate 1 ml/min, injector CP-1177, split 1:50, detector FID 39XI250° C. Evaluation in area percent; calibration (siloxanes and n-hexadecane) showed that the values in area % correspond to the same values in weight %.

Based on: Analysis of Large Linear and Cyclic Methylsiloxanes and Computer Calculation of the Chromatographic Data (Journal of Chromatographic Science 1966, 4, 347-349).

### High-Performance Liquid Chromatography (HPLC)

The composition of the methylpolysiloxane mixtures was determined by HPLC. Instrument: Agilent LC System Series 1100, degasser ERC 3215α, detector Agilent ELSD 385 with Burgner Research MiraMist® PTFE atomizer (40° C. evaporation temperature, 90° C. atomizer temperature, at 1.2 standard liters/min), column Accucore C30 (50 mm×4.6 mm, 2.6 μm), linear solvent gradient of [methanol/water (75:25 v/v)]:acetone, beginning with 50:50 to 100% acetone within 160 min at a flow rate of 2 ml/min. Evaluation in area %. Calibration showed that the values in area % correspond to the same values in weight %.

Based on: Separation of linear and cyclic poly(dimethylsiloxanes) with polymer high-performance liquid chromatography (B. Durner, T. Ehmann, F.-M. Matysik in Monatshefte Chemie 2019, 150, 1603; https://doi.org/10.1007/s00706-019-02389-4). The quantitative composition of the methylpolysiloxane mixtures was determined by combining the GC and HPLC data. This was done by utilizing the overlap region of the two methods for the constituents from Si10 to Si20 and from D10 to D19, respectively, and performing in each case an integral comparison of Siₓ to Siₓ₊ᵢ and Dₓ to Dₓ₊ᵢ, respectively, in the aforesaid ranges. In the range of equal intensity ratios, the data were combined and were continually supplemented and standardized with the aid of the above-stated intensity factors. Calibration showed that the values ascertained in area % correspond to the same values in weight %.

### Gel Permeation Chromatography (GPC)

The composition of the methylpolysiloxane mixtures, and also number average M̅ₙ, weight average M̅_{w} and polydispersity, were determined by GPC. Instrument: Iso Pump Agilent 1200, autosampler Agilent 1200, column oven Agilent 1260, detector RID Agilent 1200, column Agilent 300 mm×7.5 mm OligoPore cut-off 4500D, column material highly crosslinked polystyrene/divinylbenzenes, eluent toluene, flow rate 0.7 ml/min, injection volume 10 μl, concentration 1 g/l (in toluene), PDMS (polydimethylsiloxane) calibration (Mp 28 500 D, Mp 25 200 D, Mp 10 500 D, Mp 5100 D, Mp 4160 D, Mp 1110 D, Mp 311 D). Evaluation in area %.

### 2. Measuring the M to D Ratio (²⁹Si NMR)

The proportion of M groups (Me₃SiO_{1/2}— chain ends) and D groups (Me₂SiO_{2/2}— chain links) was determined by nuclear magnetic resonance spectroscopy (²⁹Si NMR; Bruker Avance IN HD 500 (²⁹Si: 99.4 MHz) spectrometer with BBO 500 MHz S2 probe; inverse gated pulse sequence (NS=3000); 150 mg of methylpolysiloxane mixtures in 500 μl of a 4×10⁻² molar solution of Cr(acac)₃ in CD₂Cl₂.

### 3. Measuring the Viscosity

The viscosity was determined using a Stabinger SVM3000 rotary viscometer from Anton Paar at 25° C. (standard) and also in the temperature range from −40° C. to +90° C.

### 4. Ascertaining the Critical Temperature

The critical temperature was determined by analyzing the densities in the CSP-relevant temperature range from 300 to 450° C. The fluids (50 ml each) were heated to temperatures between 50 and 450° C. for this purpose in a high-pressure and high-temperature measuring cell from LTP GmbH and loaded with pressures of 10 to 50 bar via a pressure cylinder. The respective pressure interval was analyzed at constant temperature. The respective density was determined from the resultant change in volume of the fluid under defined pressure relative to the measuring cell volume. The error of the method lies between 1% and 5%. A collapse in density reveals the critical temperature of the fluids under analysis.

### 5. Methylpolysiloxane Mixtures

Different methylpolysiloxane mixtures with defined M:D ratio were used and analyzed (cf. Tables 2 and 4):
CE1 (not inventive, M:D=1:4)=linear polydimethylsiloxane having a viscosity of around 5 mPa*s, available commercially from Wacker Chemie AG as HELISOL® 5A
Example 1 (M:D=1:15.5)=substantially linear polydimethylsiloxane having a composition as in Table 2.
Example 2 (M:D=1:18)=substantially linear polydimethylsiloxane having a composition as in Table 2.
Example 3 (M:D=1:13.5), prepared from 33.1 parts by weight of WACKER® AK5 (available from Wacker Chemie AG) and 66.9 parts by weight of a mixture of cyclic compounds D composed of 0.4 part by weight of D3, 58.1 parts by weight of D4, 32.8 parts by weight of D5 and 8.7 parts by weight of D6. The corresponding cyclic compounds are available commercially.
Example 4 (M:D=1:17)=prepared from 28.0 parts by weight of WACKER® AK5 and 72 parts by weight of a mixture of cyclic compounds D composed of 0.4 part by weight of D3, 58.1 parts by weight of D4, 32.8 parts by weight of D5, and 8.7 parts by weight of D6. The corresponding cyclic compounds are available commercially.

### 6. Equilibration of methylpolysiloxane Mixtures

In each case 2-2.3 liters of the respective methylpolysiloxane mixture with defined M:D ratio were introduced into a stainless steel autoclave (5.4 liters total volume, with analog and digital pressure transducer and jacket resistance heating with temperature sensor). Gastight sealing of the autoclave followed. After multiple vacuum degassing (3×20 mbar, 3 minutes in each case) the mixtures were blanketed with an argon atmosphere (1 bar). The autoclave was heated at 425° C. (internal temperature) for 30 days in order to obtain the thermodynamic equilibrium of the methylpolysiloxane mixtures.

This did not result in any alteration to the M:D ratio (verified by means of ²⁹Si NMR), but the equilibration did alter the molecular composition of the methylpolysiloxane mixtures. The equilibrated methylpolysiloxane mixtures obtained accordingly were used for further analysis (GC, GPC, HPLC, viscosity) (cf. Tables 3 and 4).

TABLE 2
Composition of the starting mixtures
Starting mixtures
wt %

| | CE1 a) | E1 a) | E2 a) | E3 a) | E4 a) |
|---|---|---|---|---|---|
| M:D | 1:4 | 1:15.5 | 1:18 | 1:13.5 | 1:17 |
| Si2 | | | | | |
| D3 | | | | 0.272 | 0.591 |
| Si3 | | | | 0.000 | 0.000 |
| D4 | 0.000 | 0.004 | 0.008 | 38.700 | 44.648 |
| Si4 | 0.000 | 0.000 | 0.001 | 0.000 | 0.000 |
| D5 | 0.006 | 0.010 | 0.023 | 21.807 | 20.675 |
| Si5 | 8.447 | 0.006 | 0.009 | 2.741 | 2.307 |
| D6 | 0.784 | 0.011 | 0.292 | 6.075 | 5.792 |
| Si6 | 9.442 | 0.024 | 0.031 | 3.046 | 2.574 |
| D7 | 0.184 | 0.011 | 0.024 | 0.593 | 0.947 |
| Si7 | 9.051 | 0.128 | 0.106 | 2.904 | 2.456 |
| D8 | 0.061 | 0.013 | 0.026 | 0.031 | 0.020 |
| Si8 | 8.488 | 0.390 | 0.267 | 2.741 | 2.316 |
| D9 | 0.031 | 0.021 | 0.034 | 0.017 | 0.013 |
| Si9 | 7.819 | 0.889 | 0.529 | 2.526 | 2.135 |
| D10 | 0.019 | 0.063 | 0.045 | 0.015 | 0.010 |
| Si10 | 7.095 | 1.588 | 0.857 | 2.295 | 1.941 |
| D11 | 0.013 | 0.095 | 0.055 | 0.000 | 0.009 |
| Si11 | 6.375 | 2.268 | 1.151 | 2.066 | 1.748 |
| D12 | 0.012 | 0.111 | 0.054 | 0.000 | 0.000 |
| Si12 | 5.683 | 2.787 | 1.387 | 1.848 | 1.562 |
| D13 | 0.012 | 0.033 | 0.057 | 0.000 | 0.000 |
| Si13 | 5.028 | 3.093 | 1.564 | 1.640 | 1.386 |
| D14 | 0.012 | 0.032 | 0.067 | 0.000 | 0.000 |
| Si14 | 4.425 | 3.243 | 1.687 | 1.448 | 1.223 |
| D15 | 0.013 | 0.030 | 0.062 | 0.000 | 0.000 |
| Si15 | 3.874 | 3.285 | 1.783 | 1.272 | 1.074 |
| D16 | 0.017 | 0.024 | 0.058 | 0.000 | 0.000 |
| Si16 | 3.384 | 3.231 | 1.832 | 1.109 | 0.937 |
| D17 | 0.048 | 0.021 | 0.050 | 0.000 | 0.000 |
| Si17 | 2.924 | 3.189 | 1.955 | 0.971 | 0.801 |
| D18 | 0.040 | 0.015 | 0.036 | 0.000 | 0.000 |
| Si18 | 2.567 | 3.322 | 1.964 | 0.840 | 0.700 |
| Si19 | 0.003 | 3.229 | 2.019 | 0.724 | 0.602 |
| Si20 | 2.198 | 3.199 | 1.907 | 0.639 | 0.536 |
| Si21 | 1.849 | 2.943 | 2.000 | 0.581 | 0.459 |
| Si22 | 1.705 | 3.018 | 2.018 | 0.460 | 0.438 |
| Si23 | 1.554 | 2.885 | 2.122 | 0.449 | 0.355 |
| Si24 | 1.329 | 2.806 | 2.149 | 0.426 | 0.328 |
| Si25 | 1.039 | 2.668 | 2.030 | 0.385 | 0.313 |
| Si26 | 0.903 | 2.505 | 1.904 | 0.376 | 0.298 |
| Si27 | 0.890 | 2.617 | 2.005 | 0.347 | 0.291 |
| Si28 | 0.731 | 2.379 | 2.066 | 0.327 | 0.261 |
| Si29 | 0.726 | 2.311 | 1.970 | 0.327 | 0.256 |
| Si30 | 0.634 | 2.170 | 1.940 | | |
| Si31 | 0.582 | 2.189 | 2.032 | | |
| Si32 | | 2.117 | 1.936 | | |
| Si33 | | 1.963 | 2.110 | | |
| Si34 | | 1.799 | 2.024 | | |
| Si35 | | 1.705 | 1.928 | | |
| Si36 | | 1.689 | 2.003 | | |
| Si37 | | 1.611 | 1.814 | | |
| Si38 | | 1.574 | 1.779 | | |
| Si39 | | 1.439 | 1.865 | | |
| Si40 | | 1.391 | 1.779 | | |
| Si41 | | 1.299 | 1.725 | | |
| Si42 | | 1.210 | 1.667 | | |
| Si43 | | 1.144 | 1.697 | | |
| Si44 | | 1.072 | 1.737 | | |
| Si45 | | 1.010 | 1.648 | | |
| Si46 | | 1.042 | 1.636 | | |
| Si47 | | 1.010 | 1.492 | | |
| Si48 | | 0.809 | 1.570 | | |
| Si49 | | 0.935 | 1.485 | | |
| Si50 | | 0.752 | 1.559 | | |
| Si51 | | 0.714 | 1.338 | | |
| Si52 | | 0.675 | 1.296 | | |
| Si53 | | 0.666 | 1.327 | | |
| Si54 | | 0.605 | 1.280 | | |
| Si55 | | 0.570 | 1.184 | | |
| Si56 | | 0.540 | 1.102 | | |
| Si57 | | 0.595 | 1.083 | | |
| Si58 | | 0.546 | 1.014 | | |
| Si59 | | 0.485 | 1.050 | | |
| Si60 | | 0.493 | 1.098 | | |
| Si61 | | 0.456 | 0.970 | | |
| Si62 | | 0.429 | 0.882 | | |
| Si63 | | 0.423 | 0.845 | | |
| Si64 | | 0.431 | 0.805 | | |
| Si65 | | 0.379 | 0.740 | | |
| Si66 | | 0.373 | 0.713 | | |
| Si67 | | 0.364 | 0.672 | | |
| Si68 | | 0.384 | 0.672 | | |
| Si69 | | 0.383 | 0.664 | | |
| Si70 | | 0.324 | 0.662 | | |
| Si71 | | 0.340 | 0.640 | | |
| Si72 | | 0.370 | 0.601 | | |
| Si73 | | 0.334 | 0.634 | | |
| Si74 | | 0.348 | 0.520 | | |
| Si75 | | 0.345 | 0.504 | | |
| Si76 | | | 0.546 | | |
| Si77 | | | 0.598 | | |
| Si78 | | | 0.487 | | |
| Si79 | | | 0.442 | | |
| Sum of | 1.25 | 0.49 | 0.89 | 67.24 | 72.11 |
| cyclic | | | | | |
| compounds | | | | | |

TABLE 3
Equilibrium composition of the
mixtures equilibrated at 425° C.
equilibrated 1 month @ 425° C.
wt %

| | CE1 b) | E1 b) | E2 b) | E3 b) | E4 b) |
|---|---|---|---|---|---|
| M:D | 1:4 | 1:15.5 | 1:18 | 1:13.5 | 1:17 |
| Si2 | 2.800 | 0.557 | 0.313 | 0.239 | 0.172 |
| D3 | 2.717 | 3.573 | 4.385 | 2.332 | 2.328 |
| Si3 | 4.871 | 1.016 | 0.612 | 0.456 | 0.344 |
| D4 | 15.569 | 20.590 | 23.206 | 14.046 | 14.275 |
| Si4 | 5.617 | 1.312 | 0.803 | 0.626 | 0.488 |
| D5 | 8.349 | 11.827 | 13.709 | 8.258 | 8.508 |
| Si5 | 5.712 | 1.479 | 0.912 | 0.740 | 0.571 |
| D6 | 2.051 | 3.683 | 4.180 | 2.681 | 2.813 |
| Si6 | 5.501 | 1.578 | 0.987 | 0.825 | 0.637 |
| D7 | 0.770 | 1.065 | 1.203 | 0.785 | 0.807 |
| Si7 | 5.218 | 1.655 | 1.054 | 0.898 | 0.697 |
| D8 | 0.397 | 0.464 | 0.493 | 0.291 | 0.312 |
| Si8 | 4.843 | 1.708 | 1.110 | 0.976 | 0.762 |
| D9 | 0.310 | 0.334 | 0.321 | 0.175 | 0.178 |
| Si9 | 4.424 | 1.731 | 1.143 | 1.036 | 0.816 |
| D10 | 0.101 | 0.310 | 0.278 | 0.127 | 0.141 |
| Si10 | 3.980 | 1.728 | 1.162 | 1.086 | 0.865 |
| D11 | 0.044 | 0.080 | 0.102 | 0.109 | 0.122 |
| Si11 | 3.545 | 1.710 | 1.174 | 1.129 | 0.907 |
| D12 | 0.019 | 0.047 | 0.074 | 0.113 | 0.125 |
| Si12 | 3.147 | 1.709 | 1.203 | 1.159 | 0.937 |
| D13 | 0.001 | 0.044 | 0.070 | 0.125 | 0.140 |
| Si13 | 2.764 | 1.667 | 1.224 | 1.185 | 0.969 |
| D14 | 0.011 | 0.041 | 0.070 | 0.142 | 0.154 |
| Si14 | 2.420 | 1.627 | 1.240 | 1.204 | 0.989 |
| D15 | 0.004 | 0.040 | 0.066 | 0.000 | 0.000 |
| Si15 | 2.111 | 1.574 | 1.201 | 1.219 | 1.007 |
| D16 | 0.005 | 0.040 | 0.061 | 0.000 | 0.000 |
| Si16 | 1.833 | 1.560 | 1.189 | 1.204 | 1.017 |
| D17 | 0.000 | 0.031 | 0.052 | 0.000 | 0.000 |
| Si17 | 1.585 | 1.555 | 1.099 | 1.263 | 1.046 |
| D18 | 0.000 | 0.016 | 0.031 | 0.000 | 0.000 |
| Si18 | 1.419 | 1.320 | 1.164 | 1.235 | 1.283 |
| Si19 | 1.157 | 1.420 | 1.176 | 1.263 | 1.065 |
| Si20 | 0.984 | 1.337 | 1.042 | 1.288 | 1.285 |
| Si21 | 0.923 | 1.294 | 1.088 | 1.273 | 1.168 |
| Si22 | 0.745 | 1.340 | 0.997 | 1.605 | 1.123 |
| Si23 | 0.612 | 1.182 | 1.060 | 1.329 | 1.232 |
| Si24 | 0.610 | 1.206 | 0.996 | 1.310 | 1.153 |
| Si25 | 0.569 | 1.254 | 1.078 | 1.295 | 1.178 |
| Si26 | 0.437 | 1.234 | 1.041 | 1.329 | 1.239 |
| Si27 | 0.421 | 1.018 | 1.112 | 1.374 | 1.502 |
| Si28 | 0.423 | 1.143 | 0.855 | 1.554 | 1.306 |
| Si29 | 0.349 | 1.027 | 0.901 | 1.540 | 1.509 |
| Si30 | 0.339 | 0.906 | 0.919 | 1.510 | 1.478 |
| Si31 | 0.290 | 0.903 | 1.050 | 1.532 | 1.484 |
| Si32 | | 0.893 | 0.838 | 1.447 | 1.473 |
| Si33 | | 0.880 | 0.867 | 1.408 | 1.238 |
| Si34 | | 0.848 | 0.888 | 1.380 | 1.395 |
| Si35 | | 0.830 | 0.782 | 1.381 | 1.411 |
| Si36 | | 0.746 | 0.874 | 1.302 | 1.348 |
| Si37 | | 0.751 | 0.757 | 1.303 | 1.327 |
| Si38 | | 0.733 | 0.968 | 1.225 | 1.279 |
| Si39 | | 0.742 | 0.827 | 1.197 | 1.256 |
| Si40 | | 0.657 | 0.858 | 1.177 | 1.266 |
| Si41 | | 0.679 | 0.770 | 1.120 | 1.203 |
| Si42 | | 0.647 | 0.771 | 1.091 | 1.155 |
| Si43 | | 0.638 | 0.758 | 1.093 | 1.148 |
| Si44 | | 0.583 | 0.724 | 1.045 | 1.081 |
| Si45 | | 0.575 | 0.790 | 1.021 | 1.050 |
| Si46 | | 0.514 | 0.687 | 0.972 | 1.049 |
| Si47 | | 0.519 | 0.627 | 0.913 | 1.032 |
| Si48 | | 0.527 | 0.657 | 0.907 | 1.024 |
| Si49 | | 0.501 | 0.697 | 0.872 | 0.980 |
| Si50 | | 0.469 | 0.570 | 0.864 | 0.961 |
| Si51 | | 0.507 | 0.498 | 0.834 | 0.962 |
| Si52 | | 0.464 | 0.638 | 0.820 | 0.939 |
| Si53 | | 0.437 | 0.653 | 0.760 | 0.874 |
| Si54 | | 0.440 | 0.488 | 0.768 | 0.879 |
| Si55 | | 0.469 | 0.472 | 0.737 | 0.910 |
| Si56 | | 0.503 | 0.468 | 0.688 | 0.815 |
| Si57 | | 0.372 | 0.490 | 0.657 | 0.800 |
| Si58 | | 0.401 | 0.523 | 0.653 | 0.800 |
| Si59 | | 0.353 | 0.485 | 0.624 | 0.779 |
| Si60 | | 0.383 | 0.481 | 0.606 | 0.719 |
| Si61 | | | 0.426 | 0.614 | 0.737 |
| Si62 | | | 0.461 | 0.594 | 0.707 |
| Si63 | | | | 0.547 | 0.694 |
| Si64 | | | | 0.520 | 0.653 |
| Si65 | | | | 0.523 | 0.616 |
| Si66 | | | | 0.515 | 0.607 |
| Si67 | | | | 0.476 | 0.602 |
| Si68 | | | | 0.468 | 0.576 |
| Si69 | | | | 0.462 | 0.557 |
| Si70 | | | | 0.456 | 0.545 |
| Si71 | | | | 0.437 | 0.520 |
| Si72 | | | | 0.435 | 0.508 |
| Si73 | | | | 0.402 | 0.476 |
| Si74 | | | | 0.410 | 0.473 |
| Si75 | | | | 0.408 | 0.443 |
| Sum of the | 30.35 | 42.18 | 48.30 | 29.18 | 29.90 |
| cyclic | | | | | |
| compounds | | | | | |

TABLE 4
Overview of the mixtures before and after equilibration

| | | | | | | | |
|---|---|---|---|---|---|---|---|
| | Cyclic | | | | | | |
| Molar | com- | | | | | Pressure | |
| M:D | pounds/ | Mₙ/g/ | M_{w}/g/ | | Viscosity/ | at 425° C./ | Critical |
| ratio | wt % | mol | mol | Polydispersity | mPas | filling level | temperature/° C. |

Starting mixtures

| | | | | | | | | |
|---|---|---|---|---|---|---|---|---|
| CE1 a) | 1:4 | 1.25 | 862 | 954 | 1.11 | 5.1 | — | — |
| E1 a) | 1:15.5 | 0.49 | 1793 | 2549 | 1.42 | 19.5 | — | — |
| E2 a) | 1:18 | 0.89 | 2450 | 4077 | 1.66 | 33.7 | — | — |
| E3 a) | 1:13.5 | 67.2 | 390 | 568 | 1.46 | 4.8 | — | — |
| E4 a) | 1:17 | 72.1 | 333 | 439 | 1.32 | 3.4 | — | — |

Equilibrated mixtures

| | | | | | | | | |
|---|---|---|---|---|---|---|---|---|
| CE1 b) | 1:4 | 30.4 | 427 | 746 | 1.75 | 3.21 | 23 bar/ | 400° C. |
| | | | | | | | 44% | |
| E1 b) | 1:15.5 | 42.2 | 541 | 1507 | 2.78 | 8.92 | 15.8 bar/ | 440° C. |
| | | | | | | | 44% | |
| E2 b) | 1:18 | 48.3 | 557 | 2027 | 3.64 | 11.2 | 15.0 bar/ | >450° C. |
| | | | | | | | 47% | |
| E3 b) | 1:13.5 | 29.2 | 618 | 2488 | 4.03 | 11.7 | 16.1 bar/ | >450° C. |
| | | | | | | | 45% | |
| E4 b) | 1:17 | 29.9 | 667 | 4988 | 7.47 | 14.5 | 15.9 bar/ | >450° C. |
| | | | | | | | 48% | |

As a result of the equilibration in the laboratory experiment, the initial mixtures become methylpolysiloxane mixtures which have a composition comparable to the CSP power station operation.

As a consequence of this, the viscosity drop of mixtures E1 and E2 is much more pronounced (CE1: reduction by 38%, E1: reduction by 62%, E2: reduction by 65%) than hitherto known. At the same time the vapor pressure of the equilibrated mixtures is lower than for the low molecular mass oil of the comparative example (E1: 15.8 bar, E2: 15.0 bar; CE1: 23 bar), although the mixtures E1 and E2 form significantly more low-boiling cyclic compounds (E1: 42.18 wt %, E2: 48.3 wt %; cf. CE1: 30.4 wt %). Mixtures E3 and E4 show an opposing trend in terms of viscosity: the viscosity rises during equilibration, but remains below a value of 20 mPa*s. The vapor pressure of the equilibrated mixtures E3 and E4, however, is likewise lower than for the low molecular mass oil of the comparative example.

The measurements additionally show that all of the methylpolysiloxane mixtures analyzed are still subcritical in the region of the operating temperature.

It was found that a startup operation in which the operating temperature of the heat transfer fluid utilized is brought gradually up to the desired maximum operating temperature of the plant prevents the maximum operating pressure not being exceeded in the equilibration phase.

1-13- (canceled)

14. A use for a methylpolysiloxane mixture, comprising:
(a) wherein the methylpolysiloxane mixture comprises a linear methylpolysiloxanes MDₓM, wherein x is an integer with 0≤x≤100, and wherein the mixtures have a molar M:D ratio of 1:15.5 to 1:30; or
(b) wherein the methylpolysiloxane mixture comprises a linear methylpolysiloxanes MDₓM, wherein x is an integer with 0≤x≤80 and cyclic dimethylpolysiloxanes D_{y} where y is an integer≥3, wherein the sum of the fractions of all cyclic dimethylpolysiloxanes D_{y} is 10-95 wt %, and wherein the mixtures have a molar M:D ratio of 1:10.5 to 1:30; and
wherein the methylpolysiloxane mixture is used as a heat transfer fluid in solar thermal power stations (CSP) with operating temperatures in a range of 300 to 500° C.

15. The use of claim 14, wherein with respect of the methylpolysiloxane mixtures:
(a) wherein the mixtures have a molar M:D ratio of 1:15.5-1:25; or
(b) wherein the mixtures comprise linear methylpolysiloxanes MDₓM wherein x is an integer with 0≤x≤29, and cyclic dimethylpolysiloxanes D_{y} where y is an integer with 3≤y≤0, wherein the sum of the fractions of all cyclic dimethylpolysiloxanes D_{y} is in a range of 60-80 wt %, and wherein the mixtures have a molar M:D ratio of 1:11 to 1:20.

16. The use of claim 14, wherein with respect of the methylpolysiloxane mixtures:
a) wherein the sum of the fractions of all cyclic dimethylpolysiloxanes D_{y} is in a range of 0-1 wt %, wherein the number average M̅ₙ of the mixture is in a range from 400 to 3000 g/mol, and wherein the weight average M̅_{w} of the mixture is in a range of 1000 to 5000 g/mol; or
b) wherein the mixtures comprise linear methylpolysiloxanes MDₓM wherein x is an integer with 0≤x≤29, and cyclic dimethylpolysiloxanes D_{y} where y is an integer with 3≤y≤0, wherein the sum of the fractions of all cyclic dimethylpolysiloxanes D_{y} is in a range of 60-80 wt %, and wherein the mixtures have a molar M:D ratio of 1:11 to 1:20 and the number average M̅ₙ of the mixture is in a range from 100 to 2000 g/mol and wherein the weight average M̅_{w} of the mixture is in a range from 100 to 6000 g/mol.

17. The use of claim 14, wherein the mixtures contain at most 150 ppm of T groups and at most 100 ppm of Q groups.

18. The use of claim 17, where the mixtures contain at most 100 ppm of T groups and no Q groups.

19. A methylpolysiloxane mixture, comprising:
linear methylpolysiloxanes MDₓM wherein x is an integer with 0≤x≤80 and cyclic dimethylpolysiloxanes D_{y} where y is an integer≥3, wherein the sum of the fractions of all cyclic dimethylpolysiloxanes D_{y} is 10-95 wt %, and wherein the mixture has a molar M:D ratio of 1:10.5 to 1:30.

20. The mixture claim 19, wherein the mixture comprises linear methylpolysiloxanes MDₓM where x is an integer with 0≤x≤29, and cyclic dimethylpolysiloxanes D_{y} where y is an integer with 3≤y≤0, wherein the sum of the fractions of all cyclic dimethylpolysiloxanes D_{y} is in a range of 60-80 wt %, wherein the mixture has a molar M:D ratio of 1:11 to 1:20, wherein the number average M̅ₙ of the mixture is in a range of 100 to 2000 g/mol and wherein the weight average M̅_{w} of the mixture is in a range of 100 to 6000 g/mol.

21. The mixture of claim 20, wherein the number average M̅ₙ of the mixture is in a range of 200 to 1600 g/mol and wherein the weight average M̅_{w} of the mixture is in a range of 200 to 2200 g/mol.

22. The mixture of claim 20, wherein the number average M̅ₙ of the mixture is in a range of 250 to 1400 g/mol and wherein the weight average M̅_{w} of the mixture is in a range of 250 to 2000 g/mol.

23. The mixture of claim 19, wherein the mixture contains at most 150 ppm of T groups and at most 100 ppm of Q groups.

24. The mixture of claim 23, wherein the mixture contains at most 100 ppm of T groups and no Q groups.

25. A method for operating a CSP plant, comprising the steps of:
providing methylpolysiloxane mixture comprising linear methylpolysiloxanes MDₓM wherein x is an integer with 0≤x≤80 and cyclic dimethylpolysiloxanes D_{y} where y is an integer≥3, wherein the sum of the fractions of all cyclic dimethylpolysiloxanes D_{y} is 10-95 wt %, and wherein the mixture has a molar M:D ratio of 1:10.5 to 1:30;
utilizing the methylpolysiloxane mixture as a heat transfer fluid; and
increasing the temperature gradually during startup of the plant until the operating temperature is reached.

26. The method of claim 25, wherein the gradual startup comprises the following steps:
a) establishing a start temperature which is 100° C. to 200° C. below the maximum operating temperature but is at least 100° C.;
b) holding the start temperature until a constant operating pressure is maintained for at least 3 hours;
c) increasing the operating temperature by a value in a range from 5 to 150° C.;
d) holding the temperature until a constant operating pressure is maintained for at least 3 hours; and
e) repeating steps c) and d) until the maximum operating temperature is reached.
